(19) United States
(12) Patent Application Publication
(10) Pub. No.: US 2012/0233581 A1
(43) Pub. Date: Sep. 13, 2012

(54) DESIGN SUPPORT APPARATUS FOR SEMICONDUCTOR DEVICE, DESIGN SUPPORT PROGRAM, AND LAYOUT INFORMATION GENERATING METHOD

(75) Inventor: KYOU SUZUKI, KANAGAWA (JP)

(73) Assignee: RENESAS ELECTRONICS CORPORATION

(21) Appl. No.: 13/402,440

(22) Filed: Feb. 22, 2012

(30) Foreign Application Priority Data
Mar. 10, 2011 (JP) 2011-053194

(51) Int. Cl. G06F 17/50

(52) U.S. Cl. 716/122

(57) ABSTRACT

A design support apparatus according to an aspect of the present invention includes: a terminal position setting unit that obtains, from a floor plan result generated from circuit design information, positional information on first and second connection terminals of a connection target circuit area to be connected to an inductor to be generated, and sets third and fourth connection terminals at respective positions where the first and third connection terminals and the second and fourth connection terminals can be respectively connected by a shortest wiring, the third and fourth connection terminals connecting the inductor to another circuit; and a pattern generation unit that generates a wiring pattern of the inductor based on the positions of the third and fourth connection terminals, and generates layout information on the inductor based on the wiring pattern.

### CROSS-REFERENCE TO RELATED APPLICATIONS

This application is based upon and claims the benefit of priority from Japanese patent application No. 2011-053194, filed on Mar. 10, 2011, the disclosure of which is incorporated herein in its entirety by reference.

### BACKGROUND

The present invention relates to a design support apparatus for a semiconductor device, a design support program, and a layout information generating method, and more particularly, to a design support apparatus for a semiconductor device including an inductor, a design support program, and a layout information generating method.

An inductor is used in a radio frequency (RF) circuit. In recent years, such an inductor is formed on the same semiconductor substrate as that of the RF circuit. The inductor is also called a spiral inductor because the inductor is obtained by forming a wiring pattern into a spiral shape. In this regard, a technique relating to an inductor synthesis system for generating inductor layout information is disclosed in US Patent Application Publication No. 2010/0088657.

In US Patent Application Publication No. 2010/0088657, a layout pattern of an inductor that satisfies a target characteristic condition is created in accordance with input data, and a simulation model of the created inductor is generated. FIG. 12 shows a flowchart illustrating operation of the inductor synthesis system disclosed in US Patent Application Publication No. 2010/0088657. As shown in FIG. 12, in the inductor synthesis system disclosed in US Patent Application Publication No. 2010/0088657, a layout pattern of an inductor is first determined using target characteristic information 100, a geometric constraint 102, and a process design rule 104, as input data, and a simulation model of the inductor is created (106). Subsequently, a simulation is performed based on the created simulation model, and the characteristics of the created layout pattern of the inductor are calculated by simulation (108). Then, it is determined whether the characteristics calculated by simulation satisfy the target characteristic condition (110).

If the characteristics of the inductor do not satisfy the target characteristic condition, a parameter for generating an inductor is set (112). Then, a candidate for the layout pattern of the inductor is created based on the parameter created in the process 112 (114). After that, the processes 106, 108, and 110 are carried out again. On the other hand, if the inductor characteristics satisfy the target characteristic condition, the layout pattern of the inductor and the simulation model thereof are output to a user interface (116).

### SUMMARY

In such an RF circuit incorporating an inductor, a characteristic verification process, such as back annotation or prototype evaluation, is carried out after creation of a layout pattern in which the inductor is disposed. Thus, the characteristics are finally verified in consideration of environmental effects of a circuit and the like to be connected to the inductor.

The characteristics of the inductor itself, which is generated using the inductor synthesis system disclosed in US Patent Application Publication No. 2010/0088657, can satisfy the target characteristic condition. However, in the inductor synthesis system disclosed in US Patent Application Publication No. 2010/0088657, environmental effects are not taken into consideration in the inductor characteristic evaluation. As a result, parasitic components of wiring and the like to be added to the inductor in a later process have an adverse effect on the characteristics of the inductor. This causes a problem that the inductor characteristics do not sufficiently satisfy the target characteristic condition in the back annotation or prototype evaluation, for example.

This problem will be described in more detail. FIGS. 13 and 14 show diagrams each designed by the present inventor to explain the problem caused in the inductor synthesis system disclosed in US Patent Application Publication No. 2010/0088657. FIG. 13 shows an exemplary layout pattern of the inductor generated in the inductor synthesis system disclosed in US Patent Application Publication No. 2010/0088657. FIG. 14 shows an exemplary layout pattern when the inductor shown in FIG. 13 is disposed with a circuit area including a circuit connected to the inductor.

As shown in FIG. 13, in the inductor layout pattern, a winding portion size 201 is defined inside a maximum size 200 of the inductor. A winding pattern 202 forms the inductor. A lead-out wiring pattern 203 is formed for the winding pattern 202, and the lead-out wiring pattern 203 and the winding pattern 202 are connected via a through-hole 206. A connection terminal 204 is formed at one end of the winding pattern 202, and a connection terminal 205 is formed at one end of the lead-out wiring pattern 203. The connection terminals 204 and 205 are disposed at arbitrary positions along the maximum size 200 of the inductor. In the inductor synthesis system disclosed in US Patent Application Publication No. 2010/0088657, a synthesis process is performed so that the layout pattern characteristic of the inductor satisfies the target characteristic condition.

As shown in FIG. 14, the inductor layout pattern shown in FIG. 13 is connected to each of connection terminals 211 and 212 of a circuit area 210 including a circuit connected to the inductor. In the example shown in FIG. 14, the connection terminal 211 and the connection terminal 204 are connected by a connection wiring 213, and the connection terminal 212 and the connection terminal 205 are connected by a connection wiring 214.

In the characteristic verification process, such as back annotation, the characteristics of the connection wirings 213 and 214 are verified. However, the connection wirings 213 and 214 include parasitic components (for example, a resistance, a capacitance, or an inductor). These parasitic components cause a deviation between the actual characteristics of the inductor and the characteristics calculated by a simulation in the inductor synthesis system disclosed in US Patent Application Publication No. 2010/0088657.

That is, the generation of the inductor layout pattern using the inductor synthesis system disclosed in US Patent Application Publication No. 2010/0088657 causes a problem of backtracking steps due to the characteristic deviation. If such a problem occurs, it is necessary to track back multiple steps for redesign, which results in a serious problem of an increase in development period.

A first aspect of the present invention is a design support apparatus for a semiconductor device, including: a terminal position setting unit that obtains, from a floor plan result generated from circuit design information, positional information on first and second connection terminals of a connection target circuit area to be connected to an inductor to be generated, and sets third and fourth connection terminals at respective positions where the first and third connection terminals and the second and fourth connection terminals can be respectively connected by a shortest wiring, the third and fourth connection terminals connecting the inductor to another circuit; and a pattern generation unit that generates a wiring pattern of the inductor based on the positions of the third and fourth connection terminals, and generates layout information on the inductor based on the wiring pattern.

A second aspect of the present invention is a non-transitory computer readable medium storing a design support program for a semiconductor device to be executed in a processor including a storage unit and an arithmetic unit, the design support program including: reading, from the storage unit, a floor plan result generated from circuit design information; obtaining, from the floor plan result, positional information on first and second connection terminals of a connection target circuit area to be connected to an inductor to be generated; setting third and fourth connection terminals at respective positions where the first and third connection terminals and the second and fourth connection terminals can be respectively connected by a shortest wiring, the third and fourth connection terminals connecting the inductor to another circuit; generating a wiring pattern of the inductor based on the positions of the third and fourth connection terminals; and generating layout information on the inductor based on the wiring pattern.

A third aspect of the present invention is a layout information generating method for a semiconductor device that generates layout information on an inductor depending on positions of first and second connection terminals of a connection target circuit to be connected to the inductor, the layout information generating method including: obtaining, from a floor plan result generated from circuit design information, positional information on the first and second connection terminals of a connection target circuit area to be connected to an inductor to be generated; setting third and fourth connection terminals at respective positions where the first and third connection terminals and the second and fourth connection terminals can be respectively connected by a shortest wiring, the third and fourth connection terminals connecting the inductor to another circuit; generating a wiring pattern of the inductor based on the positions of the third and fourth connection terminals; and generating layout information on the inductor based on the wiring pattern.

In the design support apparatus for a semiconductor device, the design support program, and the layout information generating method according to aspects of the present invention, the connection target circuit and the inductor can be connected by a shortest wiring, which leads to a reduction in characteristic deviation between the generated inductor and the actual inductor.

The design support apparatus for a semiconductor device, the design support program, and the layout information generating method according to aspects of the present invention are capable of reducing a characteristic deviation between the generated inductor and the actual inductor and reducing the number of backtracking steps.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram of a design support apparatus according to a first embodiment of the present invention;

FIG. 2 is a flowchart showing an operation of the design support apparatus according to the first embodiment;

FIG. 3 is a flowchart showing a detailed operation of processing in step S5b of the flowchart shown in FIG. 2;

FIG. 4 is a flowchart showing a detailed operation of processing in step S7 of the flowchart shown in FIG. 2;

FIG. 5 is a schematic diagram showing a layout pattern of a semiconductor device including an inductor generated in the design support apparatus according to the first embodiment;

FIG. 6 is a schematic diagram showing an exemplary layout pattern of a semiconductor device for explaining processing using a design support apparatus according to a second embodiment of the present invention;

FIG. 7 is a block diagram showing the design support apparatus according to the second embodiment;

FIG. 8 is a flowchart showing an operation of the design support apparatus according to the second embodiment;

FIG. 9 is a flowchart showing a detailed operation of processing in step S41 of the flowchart shown in FIG. 8;

FIG. 10 is a flowchart showing a detailed operation of processing in step S42 of the flowchart shown in FIG. 8;

FIG. 11 is a schematic diagram showing a layout pattern of a semiconductor device including an inductor generated by the design support apparatus according to the second embodiment;

FIG. 12 is a flowchart showing an operation of an inductor synthesis system disclosed in US Patent Application Publication No. 2010/0088657;

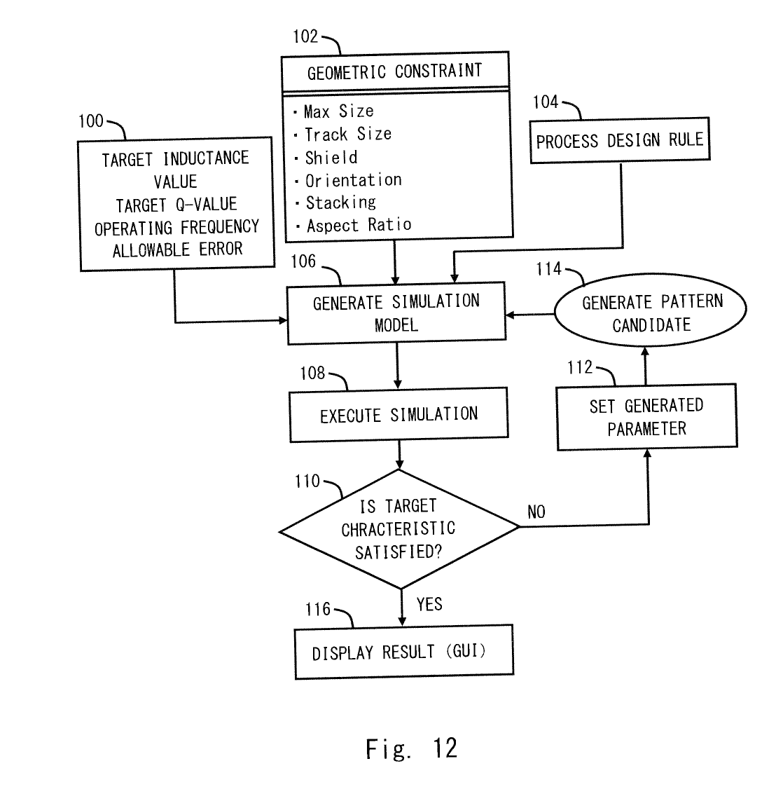

FIG. 13 is a schematic diagram showing a layout pattern of an inductor for explaining a problem of the inductor synthesis system disclosed in US Patent Application Publication No. 2010/0088657; and

FIG. 14 is a schematic diagram showing a layout pattern of a semiconductor device for explaining a problem of the inductor synthesis system disclosed in US Patent Application Publication No. 2010/0088657.

### DETAILED DESCRIPTION

### First Embodiment

Hereinafter, embodiments of the present invention will be described with reference to the accompanying drawings. A design support apparatus according to the present invention can be implemented as a dedicated apparatus. The design support apparatus according to the present invention can also be implemented by causing a computing unit such as a computer to execute a design support program. To clarify the configuration and operation of the present invention, a case will be described in which the design support apparatus is configured as a dedicated apparatus. In order to implement the functions of the design support apparatus using the design support program, processing for each block of the design support apparatus described below may be performed using the design support program.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

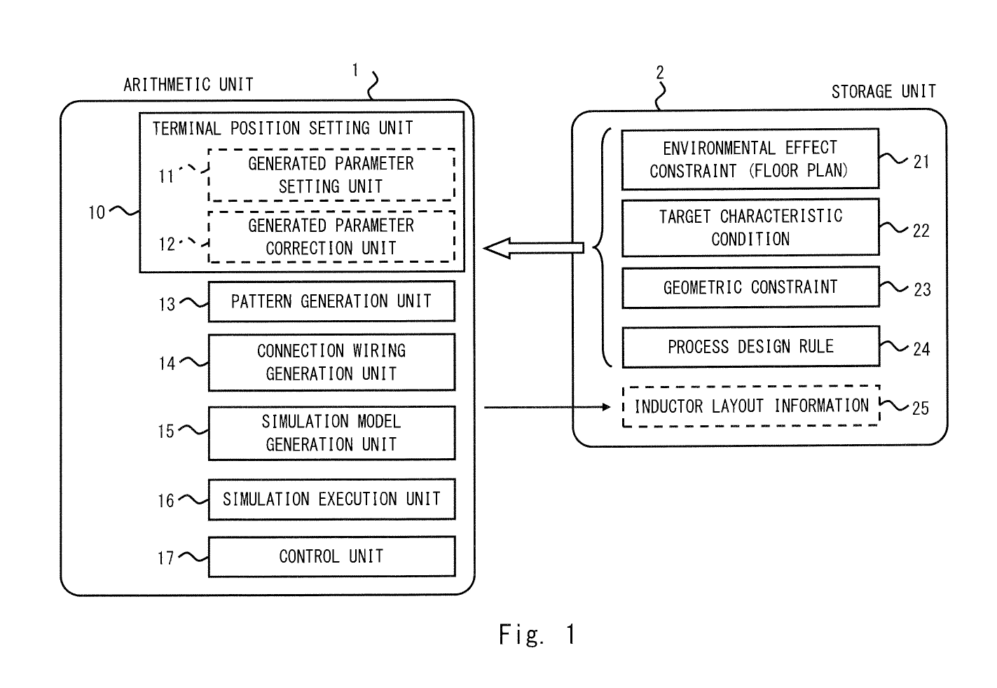

FIG. 1 shows a block diagram of a design support apparatus according to a first embodiment of the present invention. As shown in FIG. 1, the design support apparatus according to the first embodiment includes an arithmetic unit 1 and a storage unit 2. For example, a CPU (Central Processing Unit) of a computer is used as the arithmetic unit 1 when the design support apparatus is implemented by the design support program.

The arithmetic unit 1 includes a terminal position setting unit 10, a pattern generation unit 13, a connection wiring generation unit 14, a simulation model generation unit 15, a simulation execution unit 16, and a control unit 17. In the design support apparatus according to the first embodiment, the terminal position setting unit 10 and the pattern generation unit 13 can generate inductor layout information with a small characteristic deviation in a later process. The arithmetic unit 1 includes the terminal position setting unit 10 and the pattern generation unit 13, as well as the connection wiring generation unit 14, the simulation model generation unit 15, the simulation execution unit 16, and the control unit 17, thereby enabling generation of the inductor layout information with higher accuracy (with a smaller characteristic deviation in a later process).

The storage unit 2 is a storage device, such as a hard disc or a flash memory, and stores information to be used by the arithmetic unit 1. In the design support apparatus according to the first embodiment, the storage unit 2 stores an environmental effect constraint 21, a target characteristic condition 22, a geometric constraint 23, a process design rule 24, and inductor layout information 25.

The environmental effect constraint 21 is data indicating a floor plan result generated from circuit design information. The floor plan result includes a layout position of an inductor whose layout information is to be generated, and area information (such as the position, size, and terminal information) about a connection target circuit area including a circuit to be connected to the inductor. The target characteristic condition 22 is data defining target values for the characteristics of the inductor. As the target values, an inductance value, a Q-value, an operating frequency, and an allowable error of each target value are defined, for example. The geometric constraint 23 is data defining a constraint on the shape of the inductor. As the constraint on the shape, the maximum size of the inductor, the size of a winding portion, the presence or absence of a shield pattern, or a winding direction is defined, for example. The process design rule 24 is data defining a constraint determined by a manufacturing process for manufacturing a semiconductor device. As the constraint on the manufacturing process, a minimum line width of wiring, a minimum distance between wirings, or the like is defined. The inductor layout information 25 is inductor layout information generated in the arithmetic unit 1.

Subsequently, the arithmetic unit 1 will be described in more detail. The terminal position setting unit 10 obtains, from the environmental effect constraint 21 (for example, a floor plan result), positional information on first and second connection terminals in the connection target circuit area including a circuit to be connected to an inductor to be generated, and sets third and fourth connection terminals, each of which connects the inductor with an upstream/downstream circuit, to respective positions where the first and third connection terminals and the second and fourth connection terminals are connected by a shortest wiring.

In the terminal position setting unit 10 according to the first embodiment, the respective positions of the third and fourth connection terminals of the inductor are set based on the geometric constraint. After that, the positions of the third and fourth connection terminals are corrected based on the floor plan result, thereby implementing the processing described above. The terminal position setting unit 10 includes a generated parameter setting unit 11 and a generated parameter correction unit 12. The generated parameter setting unit 11 reads the geometric constraint 23 and sets the third and fourth connection terminals to preset initial positions based on the geometric constraint 23. Further, the generated parameter setting unit 11 generates coordinate information on a wiring pattern forming the inductor. Furthermore, in the first embodiment, the generated parameter setting unit 11 generates coordinate information (connection wiring generation parameter) about a connection wiring pattern.

The generated parameter correction unit 12 obtains, from the floor plan result, the positional information on the first and second connection terminals provided in the connection target circuit area, and shifts the positions of the third and fourth connection terminals of the inductor from the initial positions based on the positional information on the first and second connection terminals. In the first embodiment, the generated parameter correction unit 12 allows at least one of an X-coordinate and a Y-coordinate of the third and fourth connection terminals of the inductor to match one of an X-coordinate and a Y-coordinate of the first and second connection terminals provided in the connection target circuit area. Additionally, in the first embodiment, the generated parameter correction unit 12 corrects the coordinate information on the wiring pattern forming the inductor, depending on the positions of the third and fourth connection terminals. Note that various methods may be used to correct the parameter depending on the specifications of a tool, the degree of freedom in the extending direction of the wiring pattern (for example, depending on whether a wiring extending direction is limited to the X-direction (lateral direction) and the Y-direction (longitudinal direction), or whether an oblique direction is allowed).

The pattern generation unit 13 generates a wiring pattern of the inductor based on the positions of the third and fourth connection terminals, and generates inductor layout information based on the wiring pattern. More specifically, the pattern generation unit 13 generates a specific wiring pattern based on the positional information on the third and fourth connection terminals and the coordinate information on the wiring pattern forming the inductor. The pattern generation unit 13 uses the target characteristic condition 22, the geometric constraint 23, and the process design rule 24 so as to generate a wiring pattern.

The connection wiring generation unit 14 generates layout information on a first connection wiring connecting the first connection terminal and the third connection terminal, and layout information on a second connection wiring connecting the second connection terminal and the fourth connection terminal. In the first embodiment, the generated parameter setting unit 11 generates coordinate information (connection wiring generation parameter) about the connection wiring pattern. Accordingly, the connection wiring generation unit 14 generates a connection wiring pattern after correcting the connection wiring generation parameter.

The simulation model generation unit 15 generates a simulation model of an inductor including characteristic information on the first and second connection wirings based on the inductor layout information, the layout information on the first connection wiring, and the layout information on the second connection wiring. More specifically, the simulation model generation unit 15 generates a simulation model using a layout parasitic extraction method, such as LPE (Layout Parasitic Extract), for each layout information piece, for example. Various methods, such as a method of generating an equivalent circuit model including an electromagnetic analysis tool, an inductor, and a connection wiring, may be used to generate a simulation model.

The simulation execution unit 16 calculates a predicted characteristic of the inductor based on the simulation model. This simulation is carried out using a simulation tool capable of treating the simulation model generated by the simulation model generation unit 15. For example, SPICE (Simulation Program with Integrated Circuit Emphasis) may be used as the simulation tool.

The control unit 17 instructs the terminal position setting unit 10 to start processing for regenerating inductor layout information when the predicted characteristic calculated by the simulation execution unit 16 falls outside the range of the target characteristic condition 22. In the first embodiment, the control unit 17 is configured to perform repeated processing automatically. Alternatively, the repeated processing may be instructed by a user based on results displayed on a display screen of the design support apparatus. This eliminates the need for the control unit 17.

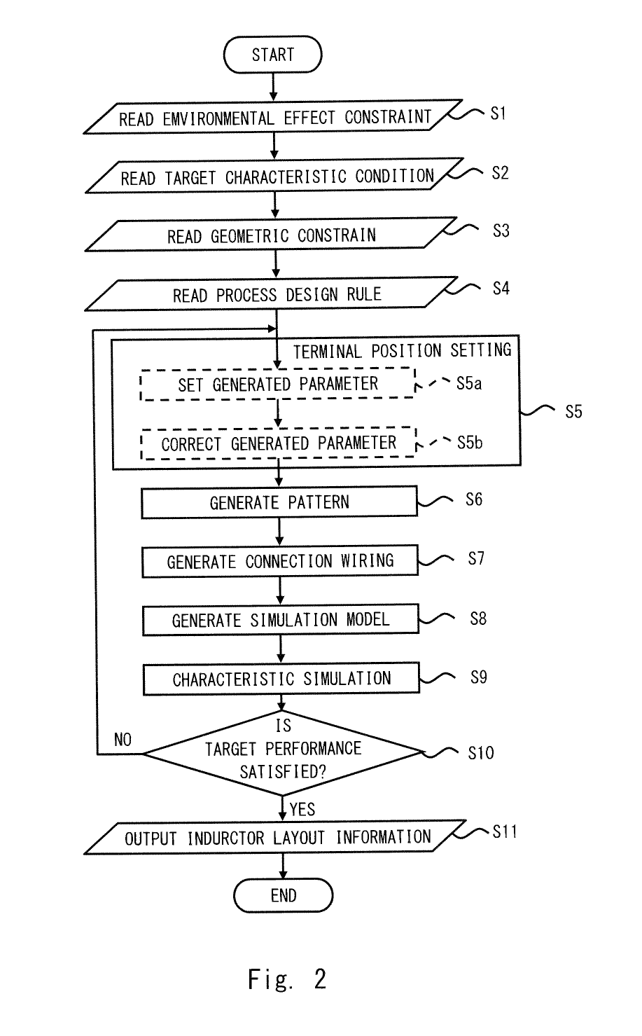

Subsequently, the operation of the design support apparatus according to the first embodiment will be described. In the following description, a circuit connected to an inductor included in the connection target circuit area is referred to as an upstream/downstream circuit, and assume that the first and second connection terminals are provided in the upstream/downstream circuit. FIG. 2 shows a flowchart illustrating operation of the design support apparatus according to the first embodiment.

As shown in FIG. 2, when processing is started in the design support apparatus, the arithmetic unit 1 reads, from the storage unit 2, information for use in inductor generation processing in steps S1 to S4. Specifically, in step S1, the environmental effect constraint (for example, a floor plan result) 21 is read. In step S2, the target characteristic condition 22 is read. In step S3, the geometric constraint 23 is read. In step S4, the process design rule 24 is read.

Next, in the design support apparatus, the terminal position setting unit 10 performs terminal position setting processing (step S5). The terminal position setting processing can be divided into two processings (processing performed by the generated parameter setting unit 11 and processing performed by the generated parameter correction unit 12). In the example shown in FIG. 2, generated parameter setting processing for obtaining, from the floor plan result, positional information on the first and second connection terminals of the upstream/downstream circuit connected to the inductor to be generated is carried out in step S5a. More specifically, in the generated parameter setting processing, the third and fourth connection terminals are arranged at predetermined initial positions based on the geometric constraint 23. In step S5a, the third and fourth connection terminals, which are respectively set to the initial positions, are connected together, and coordinate information on a wiring pattern forming the inductor is generated. Further, in step S5a, coordinate information (connection wiring parameter) on a connection wiring connecting the inductor and the upstream/downstream circuit is generated.

Subsequent to step S5a, the processing in step S5b is carried out. In step S5b, generated parameter correction processing for setting the third and fourth connection terminals, which connect the inductor and the upstream/downstream circuit, to the positions where the first and third connection terminals and the second and fourth connection terminals can be respectively connected by a shortest wiring. More specifically, in the generated parameter correction processing, the positions of the third and fourth connection terminals are shifted from the initial positions based on the positional information on the first and second connection terminals. At this time, in the generated parameter correction processing according to the first embodiment, at least one of the X-coordinate and the Y-coordinate of the third and fourth connection terminals is allowed to match one of the X-coordinate and the Y-coordinate of the first and second connection terminals. Further, in step S5a, the coordinate information on the wiring pattern forming the inductor is corrected along with the correction of the positions of the third and fourth connection terminals.

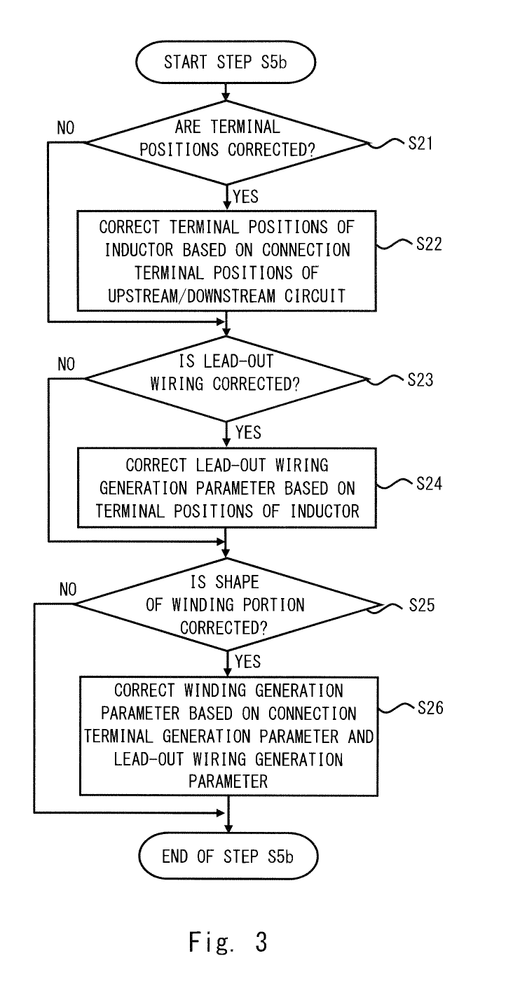

FIG. 3 shows a flowchart illustrating a more detailed operation of the generated parameter correction processing in step S5b. As shown in FIG. 3, when the generated parameter correction processing is started in the design support apparatus, it is determined whether correction of the terminal positions is required or not (step S21). In the first embodiment, when at least one of the condition that the coordinates of the position of the third connection terminal set in step S5a do not match the X-coordinate and the Y-coordinate of the first connection terminal of the upstream/downstream circuit and the condition that the coordinates of the position of the third connection terminal do not match the X-coordinate and the Y-coordinate of the first connection terminal of the upstream/downstream circuit is satisfied, it is determined that correction of the terminal positions is required, and the processing in step S22 is carried out. If both the conditions are not satisfied in step S21, the process proceeds to step S23 without performing the processing in step S22.

In step S22, the positions of the third and fourth connection terminals of the inductor are corrected based on the positions of the first and second connection terminals of the upstream/downstream circuit. Specifically, at least one of the

X-coordinate and the Y-coordinate of the third connection terminal is shifted to thereby shift the position of the third connection terminal so that the third connection terminal and the first connection terminal are located at a shortest distance. Further, at least one of the X-coordinate and the Y-coordinate of the second connection terminal is shifted to thereby shift the position of the third connection terminal so that the fourth connection terminal and the second connection terminal are located at a shortest distance. The coordinate information on the third and fourth connection terminals is hereinafter referred to as a connection terminal generation parameter.

In step S23, it is determined whether or not to correct a lead-out wiring pattern in the wiring pattern forming the inductor. Specifically, in step S23, when the position of the connection terminal to be connected to the lead-out wiring pattern is corrected in the processing of step S22, it is determined that correction of the lead-out wiring pattern is required, and the process proceeds to step S24. When the position of the connection terminal to be connected to the lead-out wiring pattern is not corrected in the processing of step S22, it is determined that correction of the lead-out wiring pattern is not necessary, and the processing of step S25 subsequent to step S23 is carried out.

In step S24, coordinate information (lead-out wiring generation parameter) on the lead-out wiring pattern is corrected based on the positions of the third and fourth connection terminals of the inductor. Specifically, the coordinate information on the lead-out wiring pattern is corrected to indicate the positions where the lead-out wiring pattern and the connection terminals can be connected together, depending on the position of one of the third and fourth connection terminals to be connected to the lead-out wiring pattern.

In step S25, it is determined whether or not to correct a winding pattern. More specifically, when at least one of the correction processings in steps S22 and S24 is carried out, the process proceeds to the processing in step S26 to correct the winding pattern of the inductor. On the other hand, when both the processings in steps S22 and S24 are not carried out, it is determined that correction of the winding pattern of the inductor is not necessary, and the generated parameter correction processing (step S5b) is finished.

In step S26, the coordinate information (winding generation parameter) on the winding pattern is corrected based on the lead-out wiring generation parameter and the connection terminal generation parameter. Specifically, in step S26, the coordinate information on the winding pattern is corrected so that the winding pattern and the lead-out wiring pattern are continuously formed and the continuous wiring patterns forming the inductor are connected to the third and fourth connection terminals. Then, step S26 is finished to thereby complete the generated parameter correction processing.

Referring next to FIG. 2, the design support apparatus performs pattern generation processing in the pattern generation unit 13 (step S6). In the pattern generation processing, the wiring pattern of the inductor is generated based on the positions of the third and fourth connection terminals, and inductor layout information is generated based on the wiring pattern. More specifically, layout information defining a specific wiring pattern is generated based on the coordinate information (connection terminal generation parameter) on the third and fourth connection terminals, the coordinate information (connection wiring generation parameter) on the lead-out wiring pattern, and the coordinate information (lead-out wiring generation parameter) on the winding pattern which are generated in the processing of step S5.

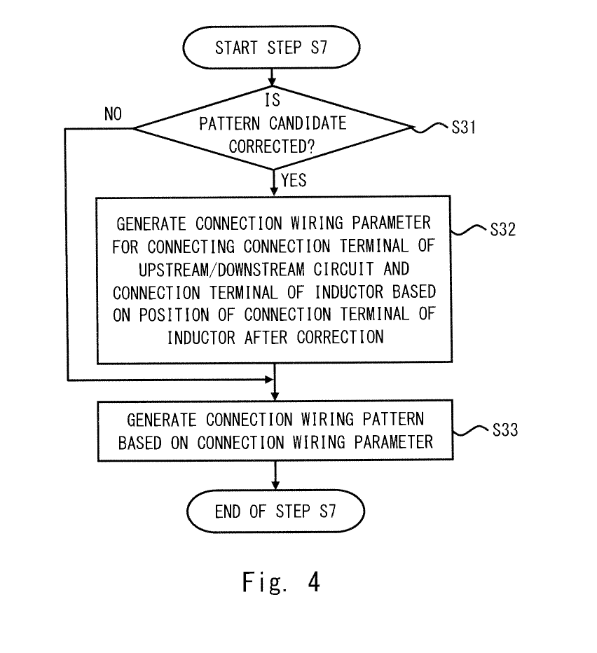

Next, the design support apparatus performs connection wiring generation processing in the connection wiring generation unit 14 (step S7). In the connection wiring generation processing, layout information on the first connection wiring, which connects the first connection terminal and the third connection terminal, and layout information on the second connection wiring, which connects the second connection terminal and the fourth connection terminal, are generated. FIG. 4 shows a flowchart illustrating a more detailed operation of the connection wiring generation processing.

As shown in FIG. 4, in the connection wiring generation processing, it is determined whether or not to correct the connection wiring generation parameter in step S31. Specifically, the determination in step S31 is made based on whether the positions of the third and fourth connection terminals of the inductor are corrected in step S5. When the positions of the third and fourth connection terminals of the inductor are corrected, the process proceeds to step S32. On the other hand, when the positions of the third and fourth connection terminals of the inductor are not corrected, the process proceeds to step S33. Note that when the connection wiring generation parameter is not generated in the generated parameter setting processing (step S5a), there is no need to carry out the processing in step S31.

In step S32, connection wiring parameter correction processing is carried out. Specifically, based on the corrected positions of the connection terminals of the inductor, the coordinate information on the first connection wiring is corrected so that the first connection terminal of the upstream/downstream circuit and the third connection terminal of the inductor are connected together, and the coordinate information on the second connection wiring is corrected so that the second connection terminal of the upstream/downstream circuit and the fourth connection terminal of the inductor are connected together. After the correction, a new connection wiring generation parameter is generated.

In step S33, a specific connection wiring pattern is generated based on the connection wiring generation parameter. The connection wiring pattern is output as layout information.

Referring next to FIG. 2, the design support apparatus performs simulation model generation processing in the simulation model generation unit 15 (step S8). Specifically, in the simulation model generation processing, the simulation model of the inductor including the characteristic information on the first and second connection wirings is generated based on the inductor layout information, the layout information on the first connection wiring, and the layout information on the second connection wiring.

Next, the design support apparatus performs a characteristic simulation in the simulation execution unit 16 (step S9). Specifically, in the characteristic simulation, a predicted characteristic of the inductor is calculated based on the simulation model generated in step S8.

Then, the design support apparatus evaluates inductor characteristics in the control unit 17 (step S10). Specifically, in the characteristic evaluation, when the predicted characteristic generated in step S9 falls outside the range of a predetermined target characteristic condition, the terminal position setting unit 10 is instructed to start processing for regenerating inductor layout information. On the other hand, in step S10, when the predicted characteristic falls within the range of the predetermined target characteristic condition, the process proceeds to step S11. In step S11, the generated inductor layout information is output to the storage unit 2.

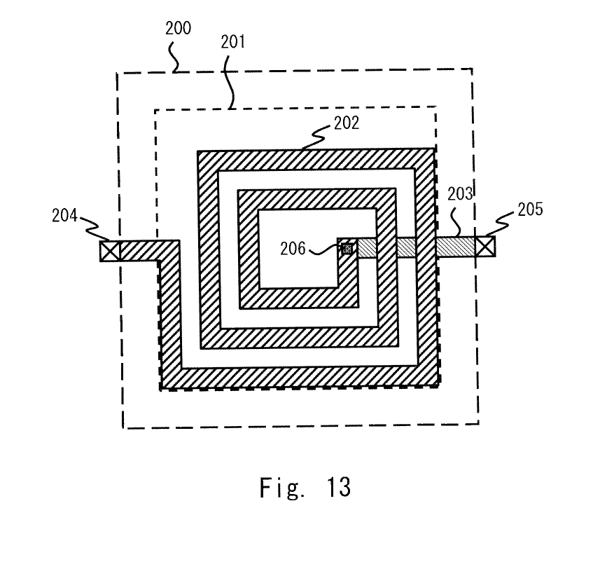

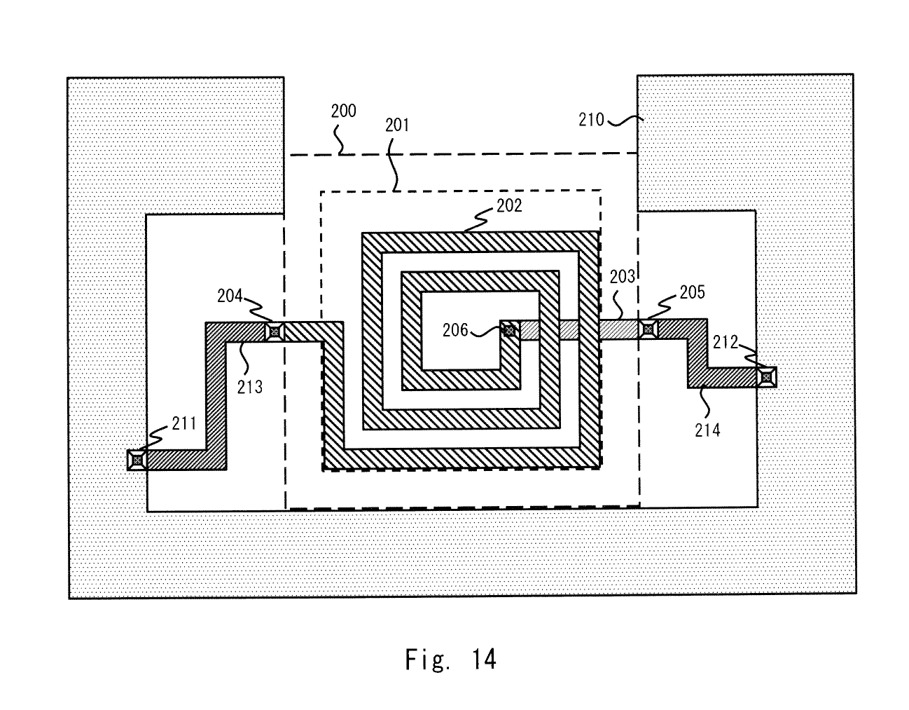

Here, the inductor layout pattern generated by the design support apparatus described above will be described in detail. In the description of the layout pattern, an inductor layout pattern (FIG. 13) generated in the inductor synthesis system disclosed in US Patent Application Publication No. 2010/0088657 is referred to as a comparative example. As shown in FIG. 13, the inductor includes a winding portion boundary 201 which defines the size of a winding portion inside a maximum size boundary 200 which defines the maximum size. A winding pattern 202 forms the inductor inside the winding portion boundary 201. One end of the winding pattern 202 is connected to one end of a lead-out wiring pattern 203 via a through-hole 206. The other end of the lead-out wiring pattern 203 is connected to a fourth connection terminal 205. A third connection terminal 204 and the fourth connection terminal 205 are arranged at arbitrary positions along the maximum size boundary 200 (for example, the outer periphery of the inductor). Referring next to a semiconductor device layout pattern (FIG. 14) including the inductor layout pattern (FIG. 13), the effect of the upstream/downstream circuit is not taken into consideration in the inductor layout pattern shown in FIG. 14. This makes it difficult to predict a distance between a first connection wiring 213 and a second connection wiring 214 when the layout pattern is used, which results in a problem of a characteristic deviation due to parasitic components such as connection wiring.

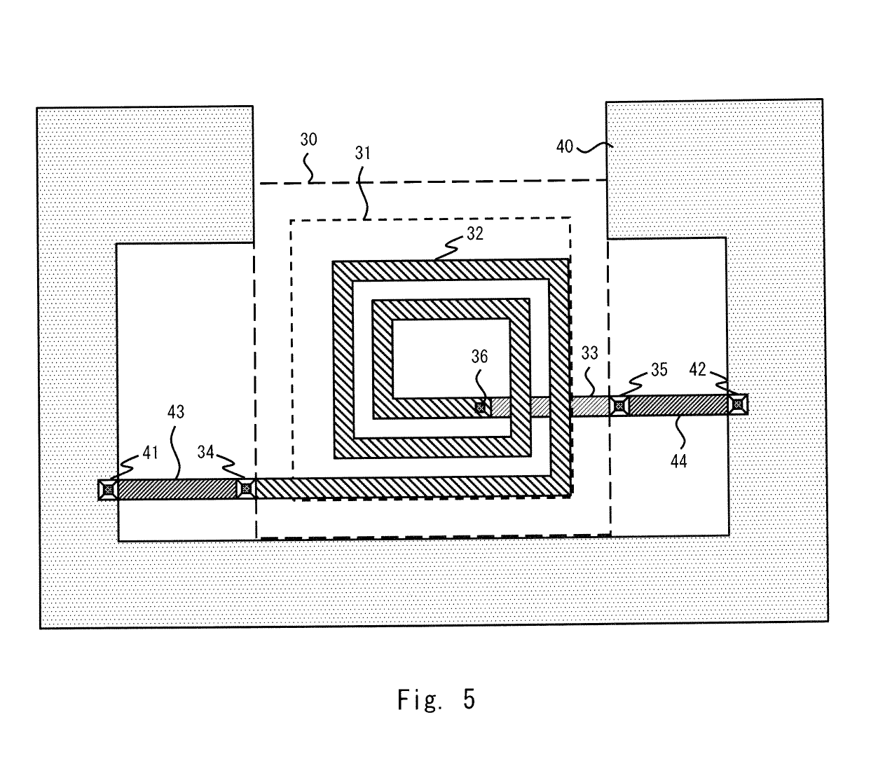

FIG. 5 shows a schematic diagram of an inductor layout pattern formed by the design support apparatus according to the first embodiment. As shown in FIG. 5, the inductor includes a winding portion boundary 31 which defines the size of a winding portion inside a maximum size boundary 30 which defines the maximum size. A winding pattern 32 forms the inductor inside the winding portion boundary 31. A third connection terminal 34 is provided at one end of the winding pattern 32. The other end of the winding pattern 32 is connected to one end of a lead-out wiring pattern 33 via a through-hole 36. The other end of the lead-out wiring pattern 33 is connected to a fourth connection terminal 35. At this time, the third connection terminal 34 and the fourth connection terminal 35 are arranged at arbitrary positions along the maximum size boundary 30 (for example, the outer periphery of the inductor). Note that the design support apparatus according to the first embodiment generates a layout pattern including a first connection terminal 41, a second connection terminal 42, a first connection wiring 43, and a second connection wiring 44, as the inductor layout pattern. FIG. 5 shows the inductor layout pattern including the first connection terminal 41, the second connection terminal 42, the first connection wiring 43, and the second connection wiring 44.

The use of the design support apparatus according to the first embodiment allows the third connection terminal 204 of the inductor shown in FIG. 14 to be moved to a new position and generated as the third connection terminal 34. The third connection terminal 34 is formed at a position where the third connection terminal 34 matches a first connection terminal 141 of the upstream/downstream circuit in the Y-coordinate. The fourth connection terminal 205 is generated as the fourth connection terminal 35 at the newly moved position. The fourth connection terminal 35 is formed at a position where the fourth connection terminal 35 matches the second connection terminal 42 of the upstream/downstream circuit in the Y-coordinate. The third connection terminal 34 and the fourth connection terminal 35 are formed at positions along the maximum size boundary 30 of the inductor also in the example shown in FIG. 5.

As shown in FIG. 5, the first connection terminal 41 and the third connection terminal 34 are connected together by the first connection wiring 43 which connects two terminals at a shortest distance. The second connection terminal 42 and the fourth connection terminal 35 are connected by the second connection wiring 44 which connects two terminals at a shortest distance. When the inductor shown in FIG. 5 is compared with the inductor shown in FIG. 14, the shape of the winding pattern 32 shown in FIG. 5 is adjusted depending on the positions of the third connection terminal 34 and the fourth connection terminal 35. The position of the lead-out wiring pattern 33 is adjusted depending on the position of the fourth connection terminal 35.

In the case of using the inductor layout pattern generated by the inductor synthesis system disclosed in US Patent Application Publication No. 2010/0088657, it is impossible to predict an increase in the length of each connection wiring and the length of each connection wiring. For this reason, when the inductor layout pattern is generated by the inductor synthesis system disclosed in US Patent Application Publication No. 2010/0088657, there is a problem that backtracking steps are required due to an increase in characteristic deviation in a later process and inability to predict the characteristic deviation.

However, the inductor generated by the design support apparatus according to the first embodiment is connected to the upstream/downstream circuit by a shortest connection wiring as shown in FIG. 5. Accordingly, the inductor has a shape which hardly causes a characteristic deviation in a later process. Furthermore, since the length of the connection wiring can be easily predicted based on the maximum size of the inductor, an appropriate value can be set for the inductor generated by the design support apparatus according to the first embodiment while taking into consideration the characteristic deviation in the target characteristic condition for the inductor generated based on the prediction. In short, the design support apparatus according to the first embodiment can generate an inductor layout pattern with a small characteristic deviation and reduce the number of backtracking steps.

The design support apparatus according to the first embodiment generates an inductor simulation model including parasitic components of the connection wiring connecting the inductor and the upstream/downstream circuit. This permits the characteristics of the inductor including the connection wiring to fall within the range of the target performance. In other words, the use of the design support apparatus according to the first embodiment enables substantial elimination of the characteristic deviation due to parasitic components of the connection wiring.

Moreover, in the design support apparatus according to the first embodiment, the inductor layout pattern is generated using the floor plan result included in the upstream/downstream circuit. The floor plan result is generated prior to generation of a detailed circuit layout of the upstream/downstream circuit.

That is, the use of the design support apparatus according to the first embodiment enables formation of an inductor having optimum characteristics in a preceding process, which results in a reduction in time required for a subsequent design flow.

The winding pattern of the inductor described above is formed in a rectangular shape. Alternatively, the winding pattern may be formed in various shapes such as a polygonal shape including a hexagonal shape and an octagonal shape, a circular shape, a winding portion symmetrical type, a center-tap type, and a transformer type. The number of turns of the winding pattern can be arbitrarily set.

### Second Embodiment

A second embodiment of the present invention illustrates an example of generating an inductor layout pattern in which characteristics including mutual coupling with a wiring (for example, a global wiring that connects circuit blocks), which is formed at a position adjacent to a wiring forming an inductor, in addition to a connection wiring connected with an upstream/downstream circuit, can satisfy a target performance.

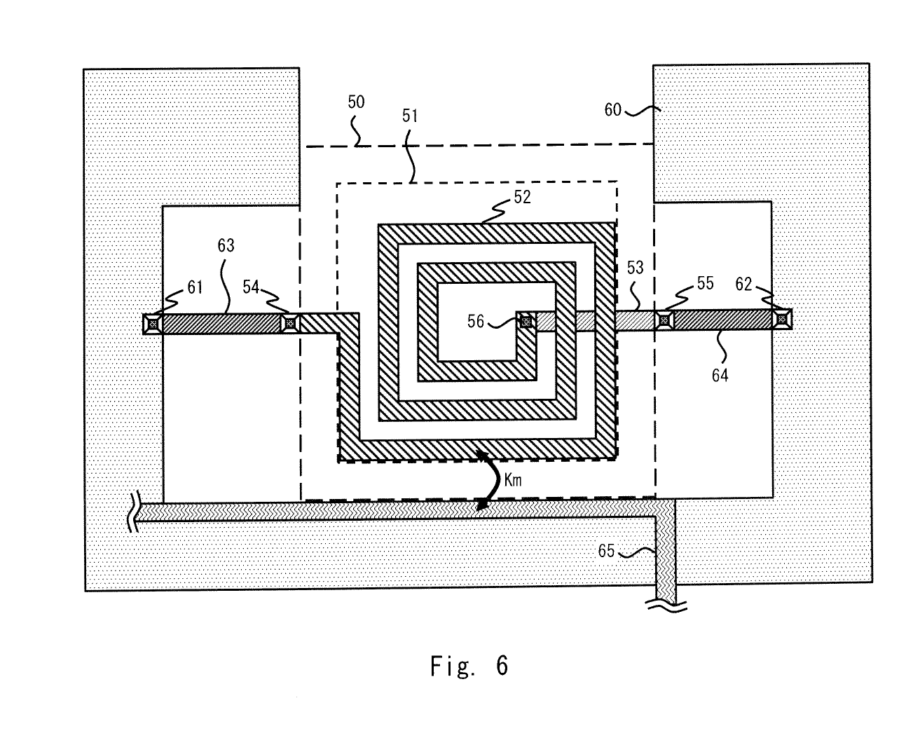

FIG. 6 shows an exemplary layout pattern to be processed by a design support apparatus according to the second embodiment. The layout pattern shown in FIG. 6 is a layout pattern in which the inductor generated in US Patent Application Publication No. 2010/0088657 is disposed. To specify the relationship with the upstream/downstream circuit, an upstream/downstream circuit 60, a first connection terminal 61, a second connection terminal 62, a first connection wiring 63, a second connection wiring 64, and a global wiring 65 are illustrated together with the inductor layout pattern. In the example shown in FIG. 6, the inductor includes a winding portion boundary 51 which defines the size of a winding portion inside a maximum size boundary 50 which defines the maximum size. A winding pattern 52 forms the inductor inside the winding portion boundary 51. A third connection terminal 54 is provided at one end of the winding pattern 52. The other end of the winding pattern 52 is connected to one end of a lead-out wiring pattern 53 via a through-hole 56. The other end of the lead-out wiring pattern 53 is connected to a fourth connection terminal 55.

In the vicinity of the inductor, the upstream/downstream circuit 60, the first connection terminal 61, the second connection terminal 62, the first connection wiring 63, and the second connection wiring 64 are arranged. The first connection wiring 63 connects the first connection terminal 61 and the third connection terminal 54 at a shortest distance. The second connection wiring 64 connects the second connection terminal 62 and the fourth connection terminal 55 at a shortest distance. In the example shown in FIG. 6, the global wiring 65 is disposed at a position adjacent to the inductor.

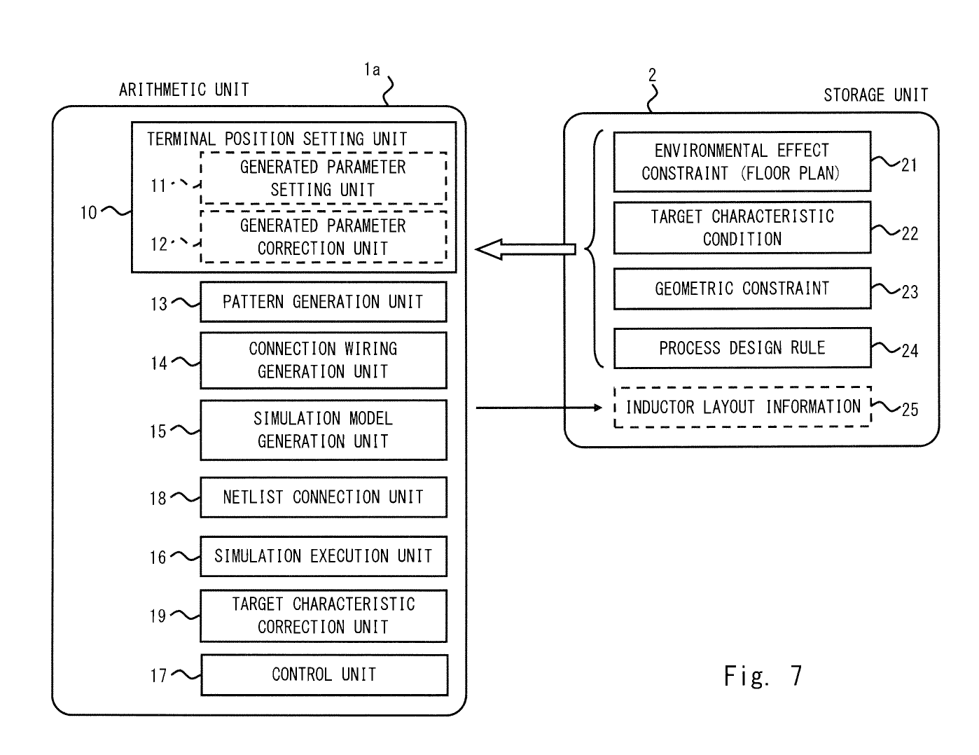

Herein, adjacent wirings of a semiconductor device have an mutual coupling Km. The characteristics of the inductor obtained after completion of the entire layout deviate from the target characteristic condition due to the mutual coupling Km. In view of this, the design support apparatus according to the second embodiment creates a simulation model in consideration of the mutual coupling Km, and the inductor is formed so that the characteristics of the inductor including the mutual coupling Km can satisfy the target characteristic condition. FIG. 7 shows a block diagram of the design support apparatus according to the second embodiment. Note that in the design support apparatus according to the second embodiment, the same components as those of the design support apparatus according to the first embodiment are denoted by the same reference numerals as those of the first embodiment, and the description thereof is omitted.

As shown in FIG. 7, the design support apparatus according to the second embodiment includes an arithmetic unit 1 a and the storage unit 2. The arithmetic unit 1 a has a configuration in which a netlist correction unit 18 and a target characteristic correction unit 19 are added to the arithmetic unit 1 according to the first embodiment.

The netlist correction unit 18 obtains, from a floor plan result, information on the adjacent wiring (for example, the global wiring 65) formed at a position adjacent to the inductor, and adds mutual coupling simulation information for simulation of an mutual coupling between the adjacent wiring and the inductor to the simulation model. Assume that the simulation model is output as a netlist.

More specifically, the netlist correction unit 18 sets a port for S-parameter analysis, generates simulation conditions, and adds the generated simulation conditions to the simulation model (netlist) generated by the simulation model generation unit 15.

The target characteristic correction unit 19 adds constraint information on the mutual coupling characteristics to a preliminarily set target characteristic condition. For example, assuming that the mutual coupling between the wiring pattern of the inductor and the global wiring is represented by Km and a target value to be satisfied by Km is represented by Kx, a constraint can be expressed as Km<Kx.

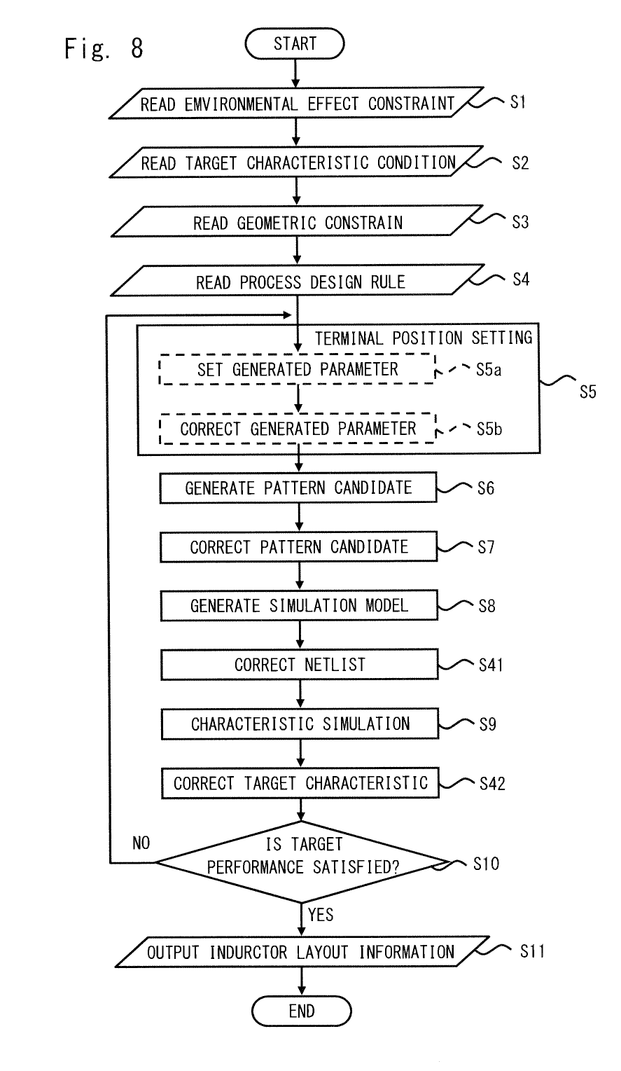

FIG. 8 shows a flowchart illustrating operation of the design support apparatus according to the second embodiment. As shown in FIG. 8, the design support apparatus according to the second embodiment performs processings in steps S41 and S42 in addition to the steps in the flowchart of the operation of the design support apparatus according to the first embodiment. Step S41 is carried out between the simulation model generation processing (step S8) and the characteristic simulation (step S9). Step S42 is carried out between the characteristic simulation (step S9) and the characteristic evaluation processing (step S10).

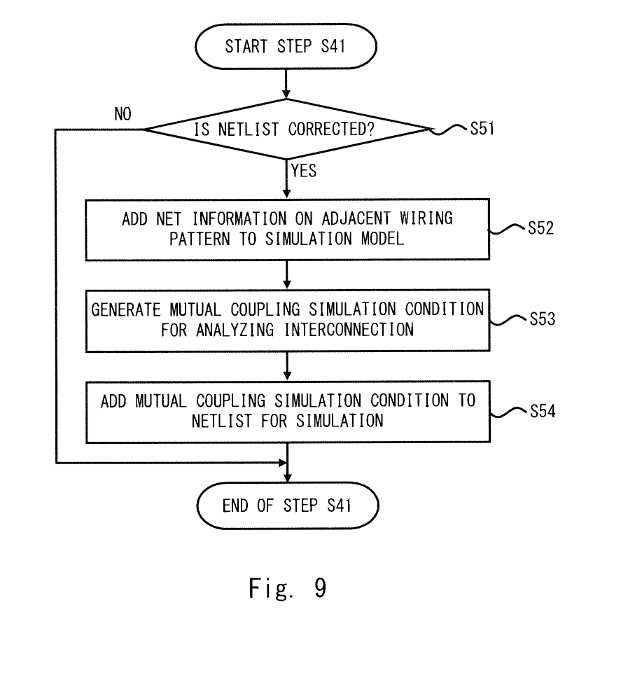

Step S41 is processing performed in the netlist correction unit 18. Specifically, in step S41, information on the adjacent wiring formed at a position adjacent to the inductor is obtained from the floor plan result, and mutual coupling simulation information for simulation of the mutual coupling between the adjacent wiring and the inductor is added to the simulation model. FIG. 9 shows a detailed flowchart of the processing in step S41.

As shown in FIG. 9, in netlist correction processing (step S41), it is first determined whether correction of the netlist is required or not (step S51). Specifically, in step S51, when the distance between the global wiring 65 and the inductor is equal to or less than a predetermined distance, it is determined that correction processing is required. As a result of the determination, when it is determined that the netlist correction processing is required, the process proceeds to step S52, and when it is determined that the netlist correction processing is not required, the netlist correction processing is finished.

In step S52, processing for adding net information on the adjacent wiring pattern to the simulation model is carried out. Subsequently, in step S53, an mutual coupling simulation condition for analyzing an mutual coupling (for example, setting of a port for S-parameter analysis) is generated. Subsequently, in step S54, the mutual coupling simulation condition is added to the simulation model. Upon completion of the processing in step S54, the netlist correction processing is completed.

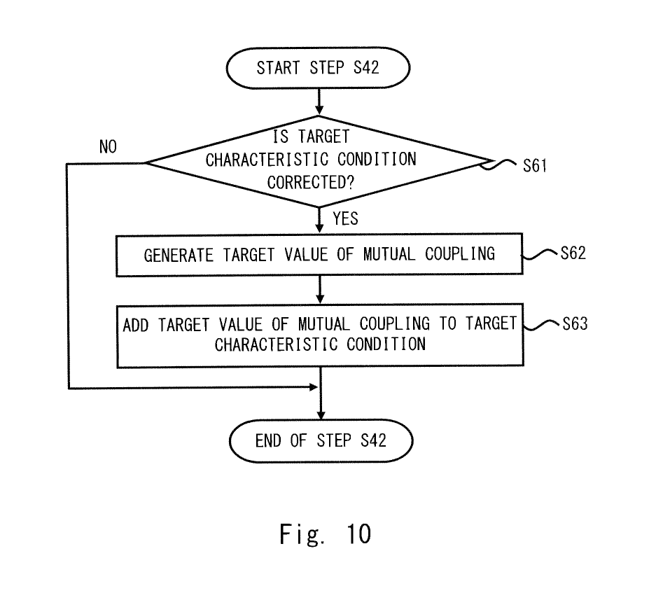

Step S42 is processing performed in the target characteristic correction unit 19. Specifically, in step S42, target characteristic condition correction processing for adding constraint information on the mutual coupling characteristic to the preliminarily set target characteristic condition is carried out. FIG. 10 shows a detailed flowchart of the processing in step S42.

As shown in FIG. 10, in the target characteristic condition correction processing (step S42), it is first determined whether correction of the target characteristic condition is required or not (step S61). Specifically, it is determined whether correction of the target characteristic condition is required or not, based on whether or not the processing in step S41 is carried out. In step S61, when the processing in step S41 is carried out, the processing in step S62 is carried out to correct the target characteristic condition. In step S61, when the processing in step S41 is not carried out, the target characteristic condition correction processing is finished without correcting the target characteristic condition.

In step S62, the target value Kx of the mutual coupling is generated. Next, in step S63, the target value Kx of the mutual coupling is added to the target characteristic condition. Upon completion of the processing in step S63, the target characteristic condition correction processing is finished.

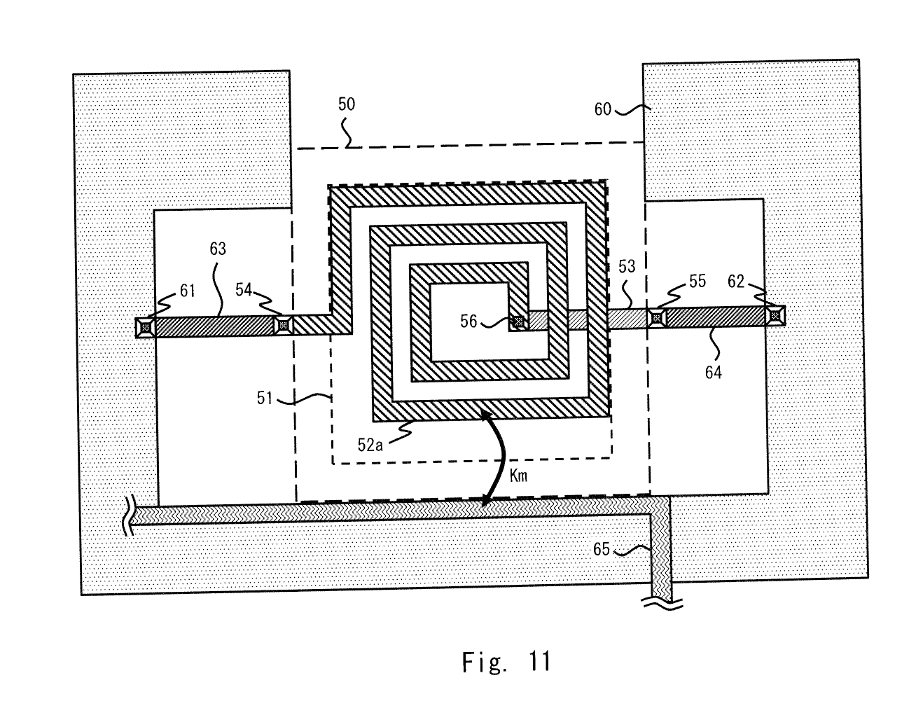

FIG. 11 shows an inductor layout pattern generated by the design support apparatus according to the second embodiment. The inductor layout pattern shown in FIG. 11 is generated such that the winding direction is corrected to be reversed with respect to that of the inductor layout pattern (for example, the inductor layout pattern shown in FIG. 6), which is generated without using the design support apparatus according to the second embodiment, and the distance from the global wiring is increased. The layout pattern shown in FIG. 11 is obtained as a result of regeneration of a pattern, which is different from that generated in a first pattern candidate generation processing, in a second pattern candidate generation processing (step S6) when the result of a first characteristic simulation does not satisfy the target performance, for example.

As described above, in the design support apparatus according to the second embodiment, a simulation is executed in consideration of the mutual coupling between wirings, and the control unit 7 executes repeated processing until the mutual coupling Km reaches the target value Kx. This enables generation of the inductor whose characteristics including the mutual coupling Km satisfy the target characteristic condition. The generation of the inductor whose characteristics including the mutual coupling Km satisfy the target characteristic condition makes it possible to further reduce a characteristic deviation caused in a later process and further reduce the number of backtracking steps as compared with the case of using the design support apparatus according to the first embodiment.

The first and second embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above. For example, the conditions used in the operation determination step can be appropriately changed.

Furthermore, it is noted that, Applicant's intent is to encompass equivalents of all claim elements, even if amended later during prosecution.

What is claimed is:

1. A design support apparatus for a semiconductor device, comprising:
a terminal position setting unit that obtains, from a floor plan result generated from circuit design information, positional information on first and second connection terminals of a connection target circuit area to be connected to an inductor to be generated, and sets third and fourth connection terminals at respective positions where the first and third connection terminals and the second and fourth connection terminals can be respectively connected by a shortest wiring, the third and fourth connection terminals connecting the inductor to another circuit; and
a pattern generation unit that generates a wiring pattern of the inductor based on the positions of the third and fourth connection terminals, and generates layout information on the inductor based on the wiring pattern.

2. The design support apparatus for a semiconductor device according to claim 1, wherein the third and fourth connection terminals are arranged along an outer periphery of an inductor forming area having the inductor formed therein.

3. The design support apparatus for a semiconductor device according to claim 1, wherein the terminal position setting unit comprises:
a generated parameter setting unit that externally reads a geometric constraint defining a shape of the inductor, and arranges the third and fourth connection terminals at preliminarily set initial positions based on the geometric constraint; and
a generated parameter correction unit that shifts the positions of the third and fourth connection terminals from the initial positions based on the positional information on the first and second connection terminals.

4. The design support apparatus for a semiconductor device according to claim 3, wherein the generated parameter correction unit allows at least one of an X-coordinate and a Y-coordinate of the third and fourth connection terminals to match one of an X-coordinate and a Y-coordinate of the first and second connection terminals.

5. The design support apparatus for a semiconductor device according to claim 1, further comprising:
a connection wiring generation unit that generates layout information on a first connection wiring that connects the first connection terminal and the third connection terminal, and layout information on a second connection wiring that connects the second connection terminal and the fourth connection terminal;
a simulation model generation unit that generates a simulation model of the inductor including characteristic information on the first and second connection wirings based on layout information on the inductor, layout information on the first connection wiring, and layout information on the second connection wiring; and
a simulation execution unit that calculates a predicted characteristic of the inductor based on the simulation model.

6. The design support apparatus for a semiconductor device according to claim 5, further comprising a simulation model correction unit that obtains, from the floor plan result, information on an adjacent wiring formed at a position adjacent to the inductor, and adds mutual coupling simulation information for simulation of an mutual coupling between the adjacent wiring and the inductor to the simulation model.

7. The design support apparatus for a semiconductor device according to claim 5, further comprising a control unit that instructs the terminal position setting unit to start processing for regenerating layout information on the inductor when the predicted characteristic falls outside a range of a preliminarily set target characteristic condition.

8. The design support apparatus for a semiconductor device according to claim 6, further comprising a target characteristic correction unit that adds constraint information on a characteristic of the mutual coupling to a preliminarily set target characteristic condition.

9. The design support apparatus for a semiconductor device according to claim 8, further comprising a control unit that instructs the terminal position setting unit to start processing for regenerating layout information on the inductor when the predicted characteristic falls outside a range of a preliminarily set target characteristic condition.

10. A non-transitory computer readable medium storing a design support program for a semiconductor device to be executed in a processor including a storage unit and an arithmetic unit, the design support program comprising:
reading, from the storage unit, a floor plan result generated from circuit design information;
obtaining, from the floor plan result, positional information on first and second connection terminals of a connection target circuit area to be connected to an inductor to be generated;
setting third and fourth connection terminals at respective positions where the first and third connection terminals and the second and fourth connection terminals can be respectively connected by a shortest wiring, the third and fourth connection terminals connecting the inductor to another circuit;
generating a wiring pattern of the inductor based on the positions of the third and fourth connection terminals; and
generating layout information on the inductor based on the wiring pattern.

11. The non-transitory computer readable medium according to claim 10, wherein the third and fourth connection terminals are arranged along an outer periphery of an inductor forming area having the inductor formed therein.

12. The non-transitory computer readable medium according to claim 10, wherein
a geometric constraint defining a shape of the inductor is read from the storage unit, and the third and fourth connection terminals are arranged are preliminarily set initial positions based on the geometric constraint, and
the positions of the third and fourth connection terminals are shifted from the initial positions based on the positional information on the first and second connection terminals.

13. The non-transitory computer readable medium according to claim 12, wherein at least one of an X-coordinate and a Y-coordinate of the third and fourth connection terminals is allowed to match one of an X-coordinate and a Y-coordinate of the first and second connection terminals.

14. The non-transitory computer readable medium according to claim 10, wherein the design support program further comprises:
generating layout information on a first connection wiring that connects the first connection terminal and the third connection terminal, and layout information on a second connection wiring that connects the second connection terminal and the fourth connection terminal;
generating a simulation model of the inductor including characteristic information on the first and second connection wirings based on layout information on the inductor, layout information on the first connection wiring, and layout information on the second connection wiring; and
calculating a predicted characteristic of the inductor based on the simulation model.

15. The non-transitory computer readable medium according to claim 14, wherein the design support program further comprises obtaining, from the floor plan result, information on an adjacent wiring formed at a position adjacent to the inductor, and adding mutual coupling simulation information for simulation of an mutual coupling between the adjacent wiring and the inductor to the simulation model.

16. The non-transitory computer readable medium according to claim 14, wherein the design support program further comprises starting processing for regenerating layout information on the inductor when the predicted characteristic falls outside a range of a preliminarily set target characteristic condition.

17. The non-transitory computer readable medium according to claim 14, wherein the design support program further comprises adding constraint information on a characteristic of the mutual coupling to a preliminarily set target characteristic condition.

18. The non-transitory computer readable medium according to claim 17, wherein the design support program further comprises starting processing for regenerating layout information on the inductor when the predicted characteristic falls outside a range of a preliminarily set target characteristic condition.

19. A layout information generating method for a semiconductor device that generates layout information on an inductor depending on positions of first and second connection terminals of a connection target circuit to be connected to the inductor, the layout information generating method comprising:
obtaining, from a floor plan result generated from circuit design information, positional information on the first and second connection terminals of a connection target circuit area to be connected to an inductor to be generated;
setting third and fourth connection terminals at respective positions where the first and third connection terminals and the second and fourth connection terminals can be respectively connected by a shortest wiring, the third and fourth connection terminals connecting the inductor to another circuit;
generating a wiring pattern of the inductor based on the positions of the third and fourth connection terminals; and
generating layout information on the inductor based on the wiring pattern.
